(19) United States
(12) Patent Application Publication
(10) Pub. No.: US 2009/0270183 A1
(43) Pub. Date: Oct. 29, 2009

(54) GAME PERFORMANCE SYSTEMS AND METHODS

(75) Inventor: Ching-Hsiang LIN, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 12/190,735

(22) Filed: Aug. 13, 2008

(30) Foreign Application Priority Data
Apr. 23, 2008 (TW) 97114797

(51) Int. Cl. G06F 17/00; A63F 9/24

(52) U.S. Cl. 463/43; 463/14

(57) ABSTRACT

Game performance systems and methods are provided. The game performance system includes a display unit, an image capture unit, and a processing unit. The display unit displays at least a board corresponding to a board game, wherein at least one game accessory is placed on the display unit. The image capture unit captures an image corresponding to the game accessory and the board displayed in the display unit. The processing unit receives the image, and performs a game decision corresponding to the board game according to the image.

### CROSS REFERENCE TO RELATED APPLICATIONS

This Application claims priority of Taiwan Patent Application No. 97114797, filed on Apr. 23, 2008, the entirety of which is incorporated by reference herein.

### BACKGROUND OF THE INVENTION

1. Field of the Invention

The disclosure relates generally to game performance systems and methods, and, more particularly to systems and methods that perform board games by integrating real game accessories and virtual boards.

2. Description of the Related Art

For types of games, board games are one of the most popular and numerous. For example, Monopoly is a popular type of board game. Users can play the game by placing game accessories on a game board.

For conventional board games, users must memorize game rules, thus to successfully play the games. However, since there are many different types of board games and each has their own corresponding game rules, complete memorization and understanding of all the different types of board games are next to impossible, thus resulting in decreased interest by users.

To solve the aforementioned problem, computerized board games have been provided. Users can place virtual game accessories on a virtual board via the computer. For the computer games, users do not need to memorize game rules. However, the enjoyment of traditional board games and their accessories is lost via a virtual environment.

### BRIEF SUMMARY OF THE INVENTION

Game performance systems and methods are provided.

An embodiment of a game performance system includes a display unit, an image capture unit, and a processing unit. The display unit displays at least a board corresponding to a board game, wherein at least one game accessory is placed on the display unit. The image capture unit captures an image corresponding to the game accessory and the board displayed in the display unit. The processing unit receives the image, and performs a game decision corresponding to the board game according to the image.

In an embodiment of a game performance method, an image is captured via an image capture unit, wherein the image includes a board corresponding to a board game displayed in a display unit, and at least one game accessory placed on the display unit. Then, a game decision corresponding to the board game is performed according to the image.

Game performance systems and methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a game performance system according to the invention;

FIG. 2 is a schematic diagram illustrating an embodiment of a display unit according to the invention;

FIG. 3 is a schematic diagram illustrating an embodiment of a placement relationship of an image capture unit, a display unit, and game accessories according to the invention;

FIG. 4 is a schematic diagram illustrating an embodiment of a storage unit according to the invention; and

FIG. 5 is a flowchart of an embodiment of a game performance method according to the invention.

### DETAILED DESCRIPTION OF THE INVENTION

Game performance systems and methods are provided.

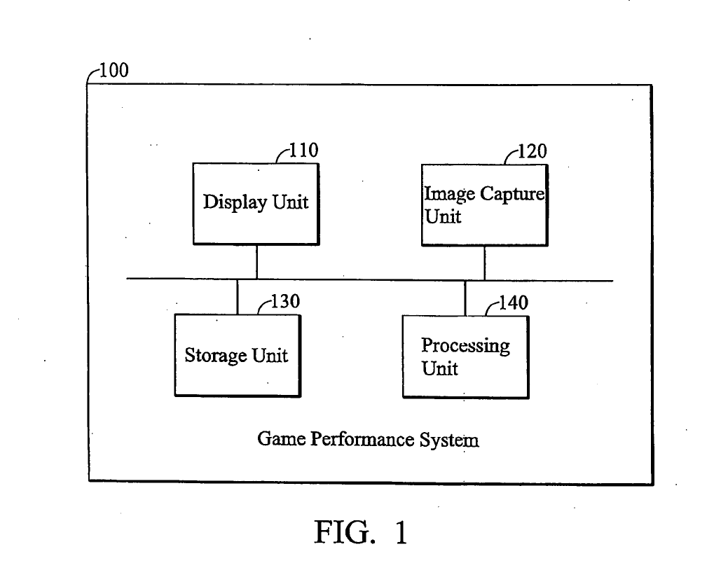

FIG. 1 is a schematic diagram illustrating an embodiment of a game performance system according to the invention.

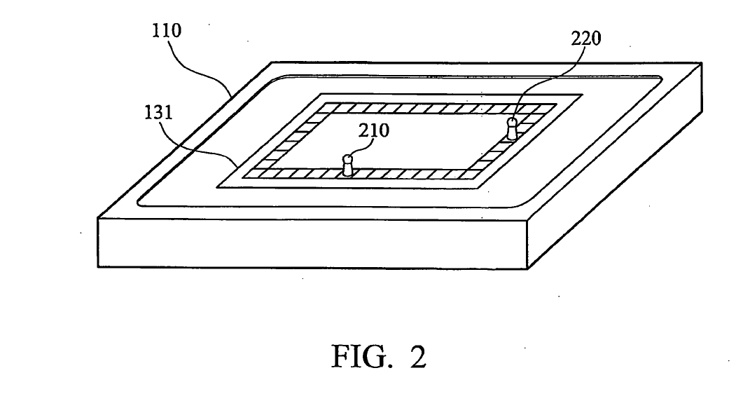

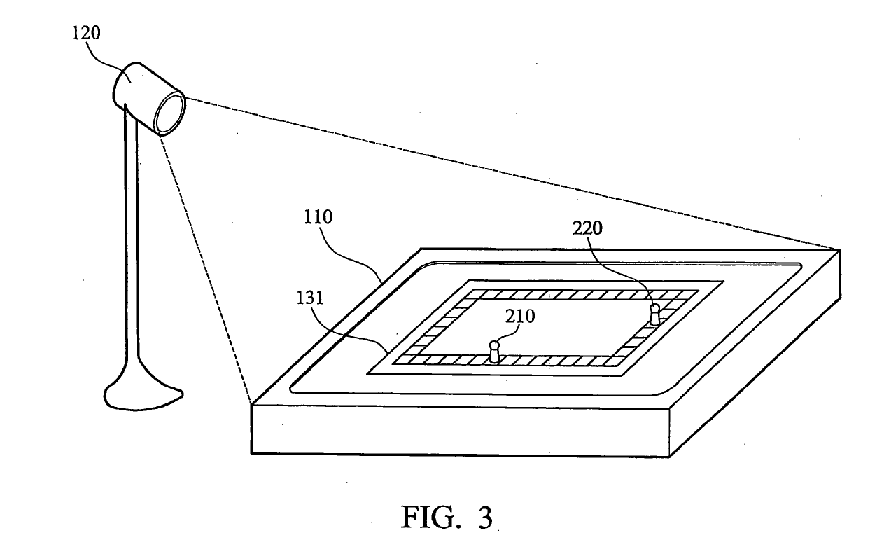

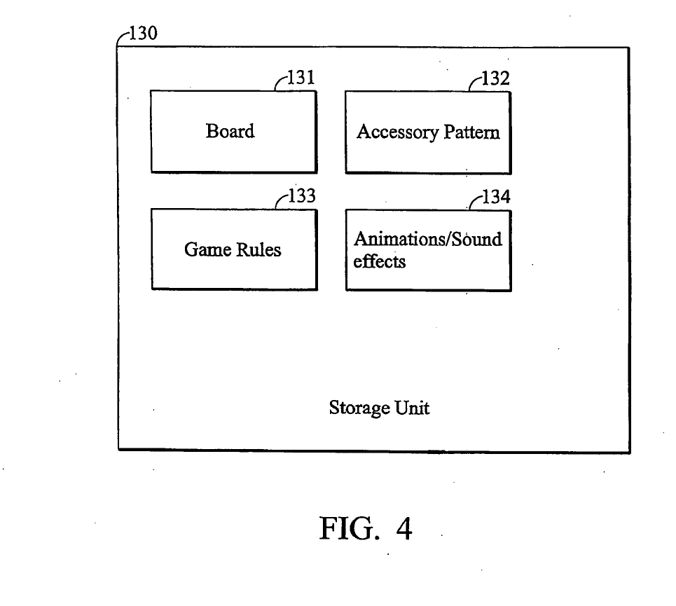

The game performance system 100 includes a display unit 110, and image capture unit 120, a storage unit 130, and a processing unit 140. The display unit 110 can display a board corresponding to at least one board game. At least one game accessory corresponding to the board game can be placed on the display unit 110. FIG. 2 is a schematic diagram illustrating an embodiment of a display unit according to the invention. As shown in FIG. 2, the display unit 110 can be horizontally positioned, and game accessories 210 and 220 are placed on the display unit 110. The display unit 110 displays a board 131, and the game accessories 210 and 220 are placed at specific positions corresponding to the board 131 displayed in the display unit 110. It is understood that, in some embodiments, several display units 110 can be composed of a complete board. The image capture unit 120 can be a camera to capture an image corresponding to the game accessories and the board displayed in the display unit 110. The placement relationship of the image capture unit 120, the display unit 110, and the game accessories 210 and 220 is shown in FIG. 3. It is noted that, the placement in FIG. 3 is only an example of the application, and is not limited thereto. Any placement, wherein the image capture unit 120 can capture an image corresponding to the game accessories and the board displayed in the display unit 110 can be applied in the application. FIG. 4 is a schematic diagram illustrating an embodiment of a storage unit 130 according to the invention. As shown in FIG. 4, the storage unit 130 can store a board 131 corresponding to a board game, at least one accessory pattern 132, at least one game rules 133, and animations and/or sound effects 134. It is understood that, in some embodiments, the storage unit 130 can store the board 131, the accessory pattern 132, the game rules 133, and the animations and/or sound effects 134 for various board games. The processing unit 140 obtains the image from the image capture unit 120, and performs the game performance method of the application. Related details are discussed later.

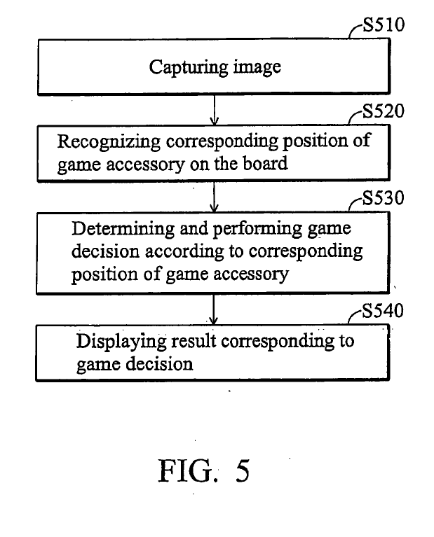

FIG. 5 is a flowchart of an embodiment of a game performance method according to the invention. In this embodiment, a board game is performed by placing game accessories on the display unit 110.

In step S510, an image is captured via the image capture unit 120. The image includes a board displayed in the display unit 110, and at least one game accessory placed on the display unit 110. It is understood that, in some embodiments, when the image only includes the game accessory, the game accessory can be recognized according to the accessory pattern 132 in the storage unit 130, and a board game can be determined according to the recognized game accessory. The board corresponding to the determined board game can be displayed in the display unit 110. Then, in step S520, a corresponding position of the game accessory on the board is recognized using the image captured by the image capture unit 120. In step S530, a game decision corresponding to the board game is determined and performed according to the corresponding position of the game accessory on the board, and in step S540, a result corresponding to the game decision is displayed in the display unit 110.

In some embodiments, the game decision may be a provision of at least one direction on the game board in the display unit 110, representing candidate positions for the game accessory during a next step of the board game. In some embodiments, the game decision may display animations and/or sound effects in the display unit 110. In some embodiments, the game decision may determine whether the position of the game accessory violates the game rules. When the position of the game accessory violates the game rules, a warning message and/or the game rules is displayed in the display unit 110. In some embodiments, the game decision may calculate game scores according to the position of the game accessory. That is, the game decision may include game rule determinations and prompts, sound and image effects corresponding to game statuses, game score calculations, game directions and teachings, and others. It is understood that, the game decision can be different based on different board games and designs, and is not limited thereto.

It is understood that, in some embodiments, users can place real game accessories on the board displayed in the displayed unit 110 to play the board game, and the system can also generate a virtual player to play the board game with users. In the embodiments, the system can automatically generate and display virtual game accessories at specific positions on the board. The game decision corresponding to the board game can be determined according to the corresponding position of the user's game accessory on the board and the specific positions of the virtual game accessories on the board. It is noted that, step S510 to step S540 can be repeated until the board game is complete or users terminate the board game. It is understood that, in some embodiments, the game progress can be stored, and used for game recovery.

Therefore, the game performance systems and methods of the application can perform board games by integrating real game accessories and virtual boards, thus maintaining the reality of real game accessories in traditional board games without memorizing complicated and complex game rules.

Game performance systems and methods, or certain aspects or portions thereof, may take the form of a program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application of specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A game performance system, comprising:
a display unit displaying at least a board corresponding to a board game, wherein at least one game accessory is placed on the display unit;
an image capture unit capturing an image corresponding to the game accessory and the board displayed in the display unit; and
a processing unit coupled to the display unit and the image capture unit to receive the image, performing a game decision corresponding to the board game according to the image.

2. The system of claim 1, wherein the processing unit further recognizes the game accessory according to the image, and determines the board game and the board displayed in the display unit according to the recognized game accessory.

3. The system of claim 1, wherein the processing unit further displays a result corresponding to the game decision in the display unit.

4. The system of claim 1, wherein the game decision comprises provision of at least one direction on the board in the display unit, representing candidate positions for the game accessory in a next step of the board game.

5. The system of claim 1, wherein the game decision comprises display of an animation or a sound effect in the display unit.

6. The system of claim 1, wherein the processing unit recognizes a corresponding position of the game accessory on the board using the image, and determines the game decision according to the position.

7. The system of claim 6, wherein the game decision comprises determination of whether the position of the game accessory violates game rules, and when the position of the game accessory violates the game rules, the processing unit further displays a warning message in the display unit.

8. The system of claim 7, wherein the processing unit further displays the game rules in the display unit.

9. The system of claim 1, wherein the game decision comprises calculation of game scores.

10. The system of claim 1, wherein the processing unit further automatically generates and displays a virtual game accessory at a specific position on the board, and determines the game decision according to the position of the game accessory and the specific position of the virtual game accessory on the board.

11. A game performance method, comprising:
capturing an image using an image capture unit, wherein the image comprises at least a board corresponding to a board game displayed in a display unit, and at least one game accessory placed on the display unit; and
performing a game decision corresponding to the board game according to the image.

12. The method of claim 11, further comprising:
recognizing the game accessory according to the image; and
determining the board game and the board displayed in the display unit according to the recognized game accessory.

13. The method of claim 11, further comprising displaying a result corresponding to the game decision in the display unit.

14. The method of claim 11, wherein the game decision comprises a provision of at least one direction on the board in the display unit, representing candidate positions for the game accessory during a next step of the board game.

15. The method of claim 11, wherein the game decision comprises display an animation or a sound effect in the display unit.

16. The method of claim 11, further comprising recognizing a corresponding position of the game accessory on the board using the image, and determining the game decision according to the position.

17. The method of claim 16, wherein the game decision comprises determination of whether the position of the game accessory violates game rules, and when the position of the game accessory violates the game rules, the method further comprises a step of displaying a warning message in the display unit.

18. The method of claim 17, further comprising displaying the game rules in the display unit.

19. The method of claim 11, wherein the game decision comprises calculation of game scores.

20. The method of claim 11, further comprising:
automatically generating and displaying a virtual game accessory at a specific position on the board; and
determining the game decision according to the position of the game accessory and the specific position of the virtual game accessory on the board.
